(19) United States
(12) Patent Application Publication
(10) Pub. No.: US 2014/0374661 A1
(43) Pub. Date: Dec. 25, 2014

(54) METHOD FOR PRODUCING SYNTHESIS GAS BY GASIFYING A BIOMASS IN A FLUIDIZED BED

(71) Applicants: Max Heinritz-Adrian, Muenster (DE); Ralf Abraham, Bergkamen (DE); Domenico Pavone, Bochum (DE)

(72) Inventors: Max Heinritz-Adrian, Muenster (DE); Ralf Abraham, Bergkamen (DE); Domenico Pavone, Bochum (DE)

(73) Assignee: THYSSENKRUPP INDUSTRIAL SOLUTIONS AG, Essen (DE)

(21) Appl. No.: 14/345,583

(22) PCT Filed: Sep. 5, 2012
(86) PCT No.: PCT/EP2012/067277

§ 371 Date: Jun. 6, 2014

(30) Foreign Application Priority Data
Sep. 19, 2011 (DE) 10 2011 114 171.9

(51) Int. Cl. C01B 3/02; B01J 8/32

(52) U.S. Cl. CPC C01B 3/02; B01J 8/32; C01B 2203/0272; C01B 2203/1211; B01J 2219/30416; B01J 2219/3086
USPC 252/373; 422/139

(57) ABSTRACT

A method for producing synthesis gas by gasifying a biomass in a fluidized bed is disclosed wherein the biomass is fed to a fluidized bed gasifier. In order to eliminate vapor-forming alkalis produced during the gasification, the method brings the synthesis gas into contact with getter ceramics.

The invention relates to a process for producing synthesis gas by gasification of a biomass in a fluidized bed, by feeding the biomass to a fluidized bed gasifier. The invention additionally relates to a plant for performance of the process.

DE 10 2010 006 192 A1 discloses a process of this kind, in which a distinct improvement in the carbon conversion in the gasification of biomass is achieved.

DE 10 2006 005 626 B4 discloses the conditioning of biomass by addition of an alkali-binding clay mineral in the course of processes for fluidized bed gasification.

One problem with the existing technology for gasification of biomasses in a fluidized bed is the fact that the alkali content in the biomass is not low. This is because these alkalis evaporate at temperatures over and above 800° C. in the gasification and diffuse partly into the pores of the lining of the fluidized bed gasifier. The incorporation of the alkalis destroys the structure of the lining. This phenomenon is known as alkali bursting. A further portion of the vaporous alkalis which form in the course of gasification of a biomass in a fluidized bed passes into a colder region of the plant downstream of the fluidized bed gasifier, in which there may be condensation and blockage, and also conglutination and degradation, for example, of the heat exchangers and warm gas filters.

This is the starting point of the invention, the object of which is to eliminate the vaporous alkalis which arise in a process for producing synthesis gas by gasification of a biomass in a fluidized bed.

A process of the type designated at the outset solves this problem in accordance with the invention, through contacting of the synthesis gas with getter ceramics.

Advantageous configurations of the invention are apparent from the dependent claims.

It has been found that there is significant alkali deposition when the alkalis are contacted directly with getter ceramics or alkali binders in contact. In terminology as used here, getter ceramics or alkali binders are substances which can bind alkalis within their structure by physical or chemical sorption. Getter ceramics are thus alkali binders. It is therefore possible to eliminate unwanted alkali vapors that arise in the course of gasification of a biomass in a fluidized bed from the product gas stream from the biomass gasification. Comparative calculations additionally show that the use of getter ceramics is very cost-effective for the avoidance of alkali bursting.

Examples of suitable getter ceramics or alkali binders by the following substances:

kaolin, bauxite, bentonite, alumina, kieselguhr, pumice, diatomaceous earth, attapulgite, pyrophyllite, andasulite, Sillimantin, mullite, barium sulfate, fuller's earth, silicon oxide, activated alumina, silicon carbide.

These alkali binders or getter ceramics can be used individually or as a mixture.

A practicable variant of the invention envisages contacting the getter ceramics with the biomass with an apparatus connected upstream of the fluidized bed gasifier. Upstream apparatuses are, for example, a weighing vessel, an entry lock or a reservoir vessel.

Preferably, the getter ceramics can also be passed directly into the fluidized bed gasifier and be contacted with the synthesis gas therein.

Studies have shown that, in the presence of steam, the binding capacity of alkalis into the getter ceramics can be increased significantly, since steam loosens up the molecular networks of the getter ceramics, such that binding, especially of large alkalis, into the intermediate spaces of the network is facilitated.

An advantageous configuration of the invention therefore envisages that vaporous alkalis present in the synthesis gas are contacted with steam.

In order to check the alkali content of the product gas, i.e. of the synthesis gas coming from the fluidized bed gasifier, a further advantageous configuration of the invention envisages that the synthesis gas is detected by a measurement probe which has been connected downstream of the fluidized bed gasifier and can measure the alkali content.

In order to further significantly reduce the costs of addition of the getter ceramics, discontinuous addition of the getter ceramics is also assured in the context of the invention. For this purpose, it is advantageous that the getter ceramics which collect in a warm gas filter connected downstream of the fluidized bed gasifier are recycled into the fluidized bed gasifier. In this case, the getter ceramics are separated together with the dust in the warm gas filter until it becomes saturated and run in circulation, i.e. conducted back into the gasifier. Studies have shown that this kind of discontinuous addition of the getter ceramics can achieve a not inconsiderable cost saving.

Finally, the invention also provides a plant for performance of the process, wherein the plant includes means of storage for the getter ceramics, i.e. a getter ceramics silo.

Further advantages, features and details of the invention are apparent on the basis of the description which follows and from the drawing. The sole FIGURE shows a plant diagram with process flow for performance of the process according to the invention.

The plant, generally labeled 1, for gasification of a biomass 2 in a fluidized bed of a fluidized bed gasifier 3 is formed essentially from the plant elements described hereinafter:

A storage apparatus 4 stores the biomass 2. By means of a lock, for example a rotary feeder 5, the material to be processed is fed first to a weighing vessel 6, then to an entry lock 7 and finally to a reservoir vessel 8.

The material from the reservoir vessel 8 is fed in turn, via a rotary feeder 9 and at least one screw 10, with two screws 10 in the embodiments illustrated, to the fluidized bed gasifier 3 and gasified therein in the fluidized bed process. The biomass 2 is converted in the fluidized bed gasifier 3 to a synthesis gas laden with alkalis.

The synthesis gas is freed of the alkalis by contacting it with getter ceramics 11 in the fluidized bed gasifier 3. For this purpose, the getter ceramics 11 are first stored in a getter ceramics silo 12 and passed through a feed line in the form of controllable rotary feeders 13 and through a further rotary feeder 14 and screw 15a, i.e. into the entry system of the fluidized bed gasifier 3 and hence into the fluidized bed gasifier 3.

Alternatively, the getter ceramics 11 stored in the getter ceramics silo 12 can be fed through the rotary feeders 13 to the apparatuses connected upstream of the fluidized bed gasifier 3, i.e. the weighing vessel 6, the entry lock 7 and the reservoir vessel 8, and thus passed into the fluidized bed gasifier 3. The synthesis gas which has been freed of alkali is fed to a recycling cyclone 14, which assures the circulation of the solid particles suitable for the fluidized bed back into the fluidized bed gasifier 3. The recycling cyclone 14 feeds the synthesis gas ultimately to the crude gas cooler 15 and through the warm gas filter 16 to subsequent use.

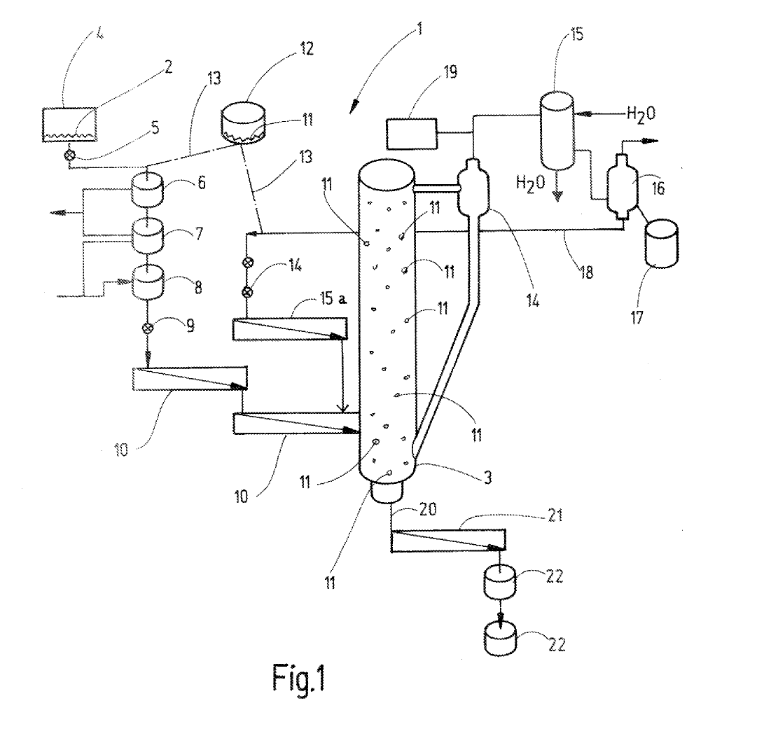

In the embodiment of the plant of the invention and of the process of the invention shown in FIG. 1, a dust silo to receive some of the dust, arranged beyond the warm gas filter 16, is given the reference numeral 17. Between the warm gas filter 16 and the entry system, there is a recycling line 18 through which, by virtue of gravity, the dust from the warm gas filter 16 can be fed back to the fluidized bed gasifier 3, and the recycling line 18 may take the form of a screw. It is also essential that the getter ceramics 11 can be conducted into the warm gas filter 16 until it becomes saturated and can be separated there together with the dust by the methods of dust deposition and conducted back through the recycling line 18 into the fluidized bed gasifier 3.

Between the recycling cyclone 14 and the crude gas cooler 15 is connected a measurement probe 19, with the aid of which it is possible to detect the alkali content of the synthesis gas and hence the quality of the synthesis gas.

Finally, the reference numeral 20 denotes the base discharge from the fluidized bed gasifier 3, and the products obtained there are again supplied by means of a screw 21 to appropriate receivers 22.

Of course, the described embodiment of the invention can also be modified in various ways without departing from the basic idea of the invention, especially with regard to the recycling of the dust or of the getter ceramics from the warm gas filter 16. In the warm gas filter 16, it is possible to use cartridge filters, for example, to separate the dust and the getter ceramics 11. There also exist further options is for transferring the getter ceramics 11 into the fluidized bed gasifier 3. For example, in the case that a torrefaction is present, or in the case of pellets, the getter ceramics 11 can be fed, respectively, to the torrefaction apparatus and to the pellet press.

### LIST OF REFERENCE NUMERALS

1 plant
2 biomass
3 fluidized bed gasifier
4 storage apparatus
5 rotary feeder
6 weighing vessel
7 entry lock
8 reservoir vessel
9 rotary feeder
10 screw
11 getter ceramics
12 getter ceramics silo
13 rotary feeder
14 recycling cyclone
15 crude gas cooler
15a screw
16 warm gas filter
17 dust silo
18 recycling line
19 measurement probe
20 base discharge
21 screw
22 receivers

1. A process for producing synthesis gas by gasification of a biomass in a fluidized bed, by feeding the biomass to a fluidized bed gasifier, wherein the synthesis gas is contacted with getter ceramics.

2. The process as claimed in claim 1,
wherein the getter ceramics are contacted with the biomass with an apparatus connected upstream of the fluidized bed gasifier.

3. The process as claimed in claim 1,
wherein the getter ceramics are passed into the fluidized bed gasifier and come into contact with the synthesis gas.

4. The process as claimed in claim 1, wherein vaporous alkalis present in the synthesis gas are contacted with steam.

5. The process as claimed in claim 1, wherein the synthesis gas is detected by a measurement probe connected downstream of the fluidized bed gasifier.

6. The process as claimed in claim 1,
wherein the getter ceramics which collect in a warm gas filter connected downstream of the fluidized bed gasifier are recycled into the fluidized bed gasifier.

7. The process as claimed in claim 2, wherein the feed of the getter ceramics into the upstream apparatuses and/or into the fluidized bed gasifier is controlled.

8. A plant for performance of the process as claimed in claim 1, comprising apparatuses connected up- and downstream of the fluidized bed gasifier, wherein it comprises a getter ceramics silo.

9. The plant as claimed in claim 8, wherein it has a measurement probe connected downstream of the fluidized bed gasifier.

10. The plant as claimed in claim 8, wherein at least one feed line is formed between getter ceramics silo and fluidized bed gasifier and/or between getter ceramics silo and apparatuses connected upstream of the fluidized bed gasifier.
